(19) United States
(12) Patent Application Publication
(10) Pub. No.: US 2023/0331747 A1
(43) Pub. Date: Oct. 19, 2023

(54) PROCESS FOR PREPARING DIALKYL ALUMINUM ALKOXIDES

(71) Applicant: ENTEGRIS, INC., Billerica, MA (US)

(72) Inventors: James M. Stubbs, Port Perry (CA); Chris Brown, Toronto (CA); Jonathan W. Dube, Bowmanville (CA); Martha Miller, Toronto (CA)

(21) Appl. No.: 18/121,559

(22) Filed: Mar. 14, 2023

Related U.S. Application Data
(60) Provisional application No. 63/320,605, filed on Mar. 16, 2022.

(51) Int. Cl. C07F 5/06

(52) U.S. Cl. CPC C07F 5/068

(57) ABSTRACT

Provided is a robust process for preparing dialkylaluminum alkoxides from trialkyl aluminum species and aluminum alkoxides, performed in a non-coordinating solvent. In certain embodiments, the reaction can be facilitated by the use of at least one static mixer.

### TECHNICAL FIELD

This disclosure relates generally to methodology for preparing dialkyl aluminum alkoxides, such as dimethylaluminum isopropoxide.

### BACKGROUND

Dialkyl aluminum alkoxides are useful as precursors in the deposition of aluminum oxide films. Current methodology for preparing such compounds, for example, dimethyl aluminum isopropoxide (CAS No. 6063-89-4) includes the reaction of trialkyl aluminum species with various alcohols at very low temperatures, or the direct reaction of trialkyl aluminum species with aluminum alkoxides.

One difficulty in the synthesis of such compounds is the pyrophoric nature of the trialkyl aluminum species and their relatively low boiling points. Additionally, the aluminum alkoxide, such as aluminum isopropoxide, is a solid. The reaction of the trialkyl aluminum species, such as trimethyl aluminum, with a solid aluminum isopropoxide is further problematic as the reaction is highly exothermic, thus requiring slow addition of the trimethylaluminum. Even then, the reaction mixture mixes poorly, and localized hot spots are often encountered. Thus, an improved process for preparing such materials which would be amenable to scaling up into the kilogram scale would be of great interest.

### SUMMARY

In summary, the disclosure provides a robust process for the preparation of dialkyl aluminum alkoxides, such as dimethyl aluminum isopropoxide. In one embodiment, a flow chemistry technique is utilized in conjunction with at least one static mixer to provide the desired compounds in good yield. In general, the disclosure provides a process for preparing a compound of the Formula (I):

(R)₂Al—OR¹ (I),
wherein each R is independently chosen from a C₁-C₈ alkyl group or phenyl, and
R¹ is a C₁-C₈ alkyl group;
which comprises mixing (i) a solution comprising a compound of the formula (R)₃Al and a non-coordinating solvent, with (ii) a solution comprising a compound of the formula Al(OR¹)₃ or a compound of the formula HOR¹ and a non-coordinating solvent.

### BRIEF DESCRIPTION OF THE DRAWINGS

FIG. 1 is a simplified flow diagram of one embodiment of the operation of the process. The trialkyl aluminum starting material (1) is combined with the aluminum alkoxide (2) in at least one static mixer (3) and allowed to proceed to reaction via a flow reaction. The product (4) in solvent is then collected and purified.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant FIGURE.

Numerical ranges expressed using endpoints include all numbers subsumed within that range (e.g., 1 to 5 includes 1, 1.5, 2, 2.75, 3, 3.80, 4 and 5).

In a first aspect, the disclosure provides a process for preparing a compound of the Formula (I):

(R)₂Al—OR¹ (I),
wherein each R is independently chosen from a C₁-C₈ alkyl group or phenyl, and
R¹ is a C₁-C₈ alkyl group;
which comprises mixing (i) a solution comprising a compound of the formula (R)₃Al and a non-coordinating solvent, with (ii) a solution comprising a compound of the formula Al(OR¹)₃ and a non-coordinating solvent.

In this process, exemplary C₁-C₈ alkyl groups include straight and branched chain alkyl groups, such as methyl, ethyl, n-propyl, isopropyl, n-butyl, isobutyl, sec-butyl, and the like.

In certain embodiments, R and R¹ are independently chosen from C₁-C₄ alkyl groups.

In one embodiment, the compound of Formula (I) is dimethyl aluminum isopropoxide. The compounds of Formula (I) are represented above by the empirical formula (R)₂Al—OR¹, but are known to exist as dimers. In other words, dimethyl aluminum isopropoxide would be represented as the following:

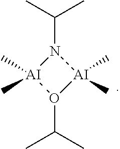

Non coordinating solvents are those solvents which are not otherwise reactive with either of the starting materials, i.e., the trialkyl aluminum species or aluminum alkoxides, or the product of Formula (I). In one embodiment, the non-coordinating solvent has a maximum boiling point at atmospheric pressure of about 95° C. Exemplary non-coordinating solvents include hydrocarbons having from 5 to 8 carbon atoms along with certain aromatic compounds, optionally substituted by C₁-C₈ alkyl groups. Exemplary non-coordinating solvents include n-pentane, isopentane, n-hexane, n-heptane, n-octane, cyclohexane, benzene, toluene, xylenes, and mixtures thereof.

Exemplary compounds of Formula (I) include those where R and R¹ are as set forth below in Table 1.

TABLE 1

| R | R¹ |
|---|---|
| methyl | methyl |
| methyl | ethyl |
| methyl | n-propyl |
| methyl | isopropyl |
| methyl | n-butyl |
| methyl | sec-butyl |
| methyl | isobutyl |
| ethyl | methyl |
| ethyl | ethyl |
| ethyl | n-propyl |
| ethyl | isopropyl |
| ethyl | n-butyl |
| ethyl | sec-butyl |
| ethyl | isobutyl |
| n-propyl | methyl |
| n-propyl | ethyl |
| n-propyl | n-propyl |
| n-propyl | isopropyl |
| n-propyl | n-butyl |
| n-propyl | sec-butyl |
| n-propyl | isobutyl |
| isopropyl | methyl |
| isopropyl | ethyl |
| isopropyl | n-propyl |
| isopropyl | isopropyl |
| isopropyl | n-butyl |
| isopropyl | sec-butyl |
| isopropyl | isobutyl |
| n-butyl | methyl |
| n-butyl | ethyl |
| n-butyl | n-propyl |
| n-butyl | isopropyl |
| n-butyl | n-butyl |
| n-butyl | sec-butyl |
| n-butyl | isobutyl |
| sec-butyl | methyl |
| sec-butyl | ethyl |
| sec-butyl | n-propyl |
| sec-butyl | isopropyl |
| sec-butyl | n-butyl |
| sec-butyl | sec-butyl |
| sec-butyl | isobutyl |
| isobutyl | methyl |
| isobutyl | ethyl |
| isobutyl | n-propyl |
| isobutyl | isopropyl |
| isobutyl | n-butyl |
| isobutyl | sec-butyl |
| isobutyl | isobutyl |

The starting material (R)₃Al and the starting material Al(OR¹)₃ are each dissolved in such non-coordinating solvents prior to the combination reaction. Advantageously, the concentration of each is high enough to ensure a speedy, facile reaction while balancing the ability to control the exothermic reaction. In certain embodiments, the starting materials are present in the non-coordinating solvent at concentrations of about 0.2 M to about 5.0M. For example, the compound of the formula (R)₃Al is dissolved in a non-coordinating solvent at a concentration of about 0.5 to about 5.0 M. In some embodiments, the compound of the formula Al(OR¹)₃ is dissolved in a non-coordinating solvent at a concentration of about 0.2 to about 4.0M. In yet another embodiment, the compound of the formula Al(OR¹)₃ is not dissolved in a non-coordinating solvent, but is added as a neat liquid, or as a pure substance that is in the liquid phase.

The following tables set forth advantageous ranges within which flow reactors may be utilized in order to mitigate reaction exotherm along with process blockages.

TABLE 2

| | | Al(O-isopropanol)₃ Solution |
|---|---|---|
| 1.5 | weight % | 0.05M |
| 15 | weight % | 0.6M |
| 50 | weight % | 3.3M |

TABLE 3

| | | TMA (Trimethyl aluminum) Solution |
|---|---|---|
| 1.5 | weight % | 0.14M |
| 20 | weight % | 1.9M |
| 50 | weight % | 5.0M |

TABLE 4

| | | Isopropanol Solution |
|---|---|---|
| 1.5 | weight % | 0.18M |
| 16 | weight % | 1.6M |
| 50 | weight % | 6.1M |

The starting material reactants R—Al and Al(OR¹)₃ readily react when combined. Advantageously, the reaction is conducted at temperatures of about 10° C. to about 95° C.

Additionally, in one embodiment, one or more static mixer(s) is(are) utilized. If more than one is utilized, the mixers may be joined in series to facilitate mixing and reaction of the starting materials. Such static mixers are widely available commercially, for example, from McMaster-Carr (www.mcmaster.com). In some embodiments, mixing is conducted at a temperature of greater than about 10° C.

In another embodiment, the starting material of the formula (R)₃Al is distilled prior to use either under atmospheric or reduced pressure. In another embodiment, the compound of the formula Al(OR¹)₃ is filtered prior to use.

In certain embodiments, the process is conducted at temperatures of about 5° C. to about 95° C., or about 10° C. to about 40° C. In this regard, the starting materials can be utilized at room temperature and the apparatus is operated at the recited temperature ranges.

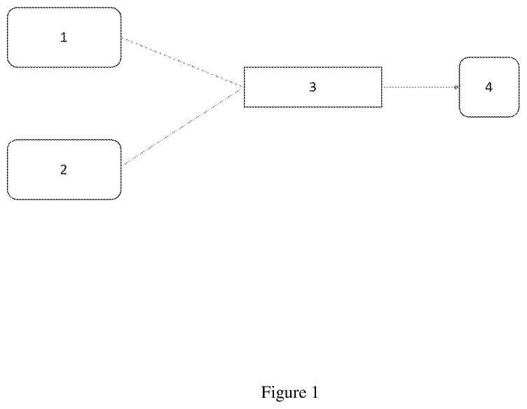

Once the product of Formula (I) is collected ((4) as depicted in FIG. 1), it can be further purified by removal of solvent and distillation.

In another aspect, the compound Formula (I) can be prepared from a solution comprising a compound of the formula (R)₃Al and a non-coordinating solvent, with a solution comprising a compound of the formula HOR¹ and a non-coordinating solvent. In this regard, exemplary compounds of the formula HOR¹ include methanol, ethanol, n-propanol, isopropanol, and the like.

The dialkyl aluminum alkoxide compounds of Formula (I) will have limited amounts of residual non-coordinating solvent present upon purification. Accordingly, in a further aspect, the disclosure provides a compound of the Formula (I):

(R)₂Al—OR¹ (I),
wherein each R is independently chosen from a C₁-C₈ alkyl group, and R¹ is a C₁-C₈ alkyl group; wherein the compound comprises about 20 to about 2000 ppm of a non-coordinating solvent.

In some embodiments, the compound includes a range from about 20 ppm to about 2000 ppm, about 50 ppm to about 2000 ppm, about 100 ppm to about 2000 pm, about 250 ppm to about 2000 ppm, about 20 ppm to about 1500 ppm, about 50 ppm to about 1500 ppm, about 100 ppm to about 1500 ppm, about 250 ppm to about 1500 ppm, about 20 ppm to about 1000 ppm, about 50 ppm to about 1000 ppm, about 100 ppm to about 1000 ppm, about 250 ppm to about 1000 ppm of a non-coordinating solvent, and all ranges and subranges therebetween.

Insofar as the process of the disclosure overcomes many of the problems of prior processes, the product of Formula (I) is also found to have superior purity. Thus, in a further aspect, the disclosure provides a compound of the Formula (I):

(R)₂Al—OR¹ (I),
wherein each R is independently chosen from a C₁-C₃ alkyl group, and R¹ is a C₁-C₃ alkyl group; wherein the compound comprises no more than about 1200 ppm of a trimer or tetramer of a compound of Formula (I) and/or no more than about 2500 ppm of combined trimer/tetramer of a compound of Formula (I).

In some embodiments, the compound includes no more than about 1200 ppm, about 1000 ppm, about 900 ppm, about 800 ppm, or about 700 ppm of a trimer or tetramer of a compound of Formula (I). In some embodiments, the compound may also include no more than about 2500 ppm, about 2250 ppm, about 2000 ppm, about 1750 ppm, about 1500 ppm or about 1250 ppm of combined trimer and tetramer of a compound of Formula (I).

In one embodiment of this aspect, the compound of Formula (I) is dimethyl aluminum isopropoxide.

In another embodiment, the disclosure provides a process for preparing a compound of the Formula (II):

(R)Al—(OR¹)₂ (II),
wherein each R is independently chosen from a C₁-C₈ alkyl group or phenyl, and R¹ is a C₁-C₈ alkyl group;
which comprises mixing (i) a solution comprising a compound of the formula (R)₃Al and a non-coordinating solvent, with (ii) a solution comprising a compound of the formula Al(OR¹)₃ and a non-coordinating solvent.

Non-coordinating solvents suitable for the process to produce compounds of Formula II are described above for compounds of Formula I. Exemplary compounds of Formula (II) include those where R and R¹ are the same as set forth above for compounds of Formula I. The aspects of the invention allow the molar stoichiometry to be tuned to specifically isolate compounds of Formula (II)

In one embodiment, the compound of Formula (II) is diethoxy ethyl aluminum.

The following examples further illustrate the invention but, of course, should not be construed as in any way limiting its scope.

### EXAMPLE 1

Aluminum isopropoxide (445 g, 2.18 mol, 1.05 equiv.) was charged to a 5 L vessel and dissolved in 2.5 kg of heptane to generate a 15 weight percent solution. Trimethylaluminum (300 g, 4.16 mol, 1.00 equiv.) was charged to a 5 L vessel and diluted with 1.2 kg of heptane to generate a 20 weight percent solution. Both vessels were connected to a flow reactor containing: two needle nose valves, two static mixers, a 3 ft coil, and two temperature probes and a 12 L receiving vessel. Both room temperature solutions were flowed through the reactor keeping the temperature between 20° C. and 40° C. Increased temperatures relative to ambient temperature were observed at both temperature probe indicating a reaction. A sample was withdrawn immediately after the completion of the flow solutions. ¹H NMR spectroscopy showed complete conversion to dimethylaluminum isopropoxide (89% crude purity) with no remaining trimethylaluminum. Solvent was removed at 50° C. and product distilled under vacuum at 60° C. to yield a clear colorless solution of dimethylaluminum in 75% yield. The trimer content was determined to be 400 ppm and the tetramer content was determined to be 1200 ppm. The results demonstrate it is possible to obtain a compound of Formula (I) with no more than about 1200 ppm of a trimer or tetramer of the compound of Formula (I) and no more than about 2500 ppm of combined trimer/tetramer of a compound of Formula (I).

### EXAMPLE 2

Aluminum isopropoxide (445 g, 2.18 mol, 1.05 equivalents) was charged to a 5 L vessel and dissolved in 2.5 kg of heptane to generate a 15 weight percent solution. The aluminum isopropoxide was filtered through a glass frit into another 5 L vessel. Trimethylaluminum (300 g, 4.16 mol, 1.00 equiv.) was charged to a 5 L vessel and diluted with 1.2 kg of heptane to generate a 20 weight percent% solution. Both vessels were connected to simplistic flow reactor containing: two needle nose valves, two static mixers, a 3 ft coil, and two temperature probes to a 12 L receiving vessel. Both room temperature solutions were flowed through the reactor keeping the temperature between 20° C. and 40° C. Increased temperatures relative to ambient temperature were observed at both temperature probe indicating a reaction. A sample was withdrawn immediately after the completion of the flow solutions. 1H NMR spectroscopy showed complete conversion to dimethylaluminum isopropoxide (88% crude purity) with no remaining trimethylaluminum. Solvent was removed at 50° C. and product distilled under vacuum at 60° C. to yield a clear colorless solution of dimethylaluminum in 75% yield. The trimer content was determined to be 170 ppm and the tetramer content was determined to be 490 ppm. The results demonstrate it is possible to obtain a compound of Formula (I) with no more than about 1200 ppm of a trimer or tetramer of the compound of Formula (I) and no more than about 2500 ppm of combined trimer/tetramer of a compound of Formula (I).

### EXAMPLE 3

Isopropanol (6.1 g, 0.10 mol, 1.02 equiv.) was charged to a 50 mL vessel and diluted in 43 mL of heptane to generate a 15 weight % solution. Trimethylaluminum (2.0 M, 50 mL, 0.10 mol, 1.00 equiv.) was charged to a 50 mL vessel. Both vessels were connected to simplistic flow reactor containing: a static mixer, a 3 ft coil, and two temperature probes to a 500 mL receiving vessel. Both room temperature solutions were flowed through the reactor keeping the temperature between 25° C. and 85° C. Higher temperatures were observed at the first temperature probe indicating a reaction. A sample was withdrawn immediate after the completion of the flow solutions. ¹H NMR spectroscopy showed 98% conversion to dimethylaluminum isopropoxide (95% crude purity) with 2% trimethylaluminum remaining.

### EXAMPLE 4

Trimethylaluminum (2.0 M, 5 mL, 0.01 mol, 1.00 equiv.) in heptane was charged to a 40 mL vial containing a stir bar. Ethanol (0.46 g, 0.01 mol, 1.0 equiv.) as a 20 weight % solution in heptane was added slowly over 5 minutes to the trimethylaluminum with stirring with gas observed. The reaction temperature was kept between 25° C. and 85° C. A sample was withdrawn immediate after the completion of the addition. ¹H NMR spectroscopy showed 85% conversion to dimethylaluminum ethoxide with 5% trimethylaluminum remaining.

### EXAMPLE 5

Trimethylaluminum (2.0 M, 5 mL, 0.01 mol, 1.00 equiv.) in heptane was charged to a 40 mL vial containing a stir bar. Methanol (0.32 g, 0.01 mol, 1.0 equiv.) as a 20 weight % solution in heptane was added slowly over 5 minutes to the trimethylaluminum with stirring with gas observed. The reaction temperature was kept between 25° C. and 85° C. A sample was withdrawn immediate after the completion of the addition. ¹H NMR spectroscopy showed 76% conversion to dimethylaluminum methoxide with 19% trimethylaluminum remaining.

Conversion values were determined by ¹H NMR spectroscopy using a 400 mHz Burker instrument. Purity profiles described were determined by gas chromatography (Agilent 7890B with a 5977 quadruple MSD). Separation was achieved on the GC column. Upon exit, the molecules were ionized using electron impaction ionization (70 eV). The MSD collected a full mass spectrum (10-700 amu) approximately once per second.

### ASPECTS OF THE INVENTION

In a first aspect, the disclosure provides a process for preparing a compound of the Formula (I):

(R)₂Al—OR¹ (I),
wherein each R is independently chosen from a C₁-C₈ alkyl group, and R¹ is a C₁-C₈ alkyl group;
which comprises mixing (i) a solution comprising a compound of the formula (R)₃Al and a non-coordinating solvent, with (ii) a solution comprising a compound of the formula Al(OR¹)₃ and a non-coordinating solvent.

In a second aspect, the disclosure provides a process for preparing a compound of the Formula (I):

(R)₂Al—OR¹ (I),
wherein each R is independently chosen from a C₁-C₈ alkyl group, and R¹ is a C₁-C₈ alkyl group;
which comprises mixing (i) a solution comprising a compound of the formula (R)₃Al and a non-coordinating solvent, with (ii) a solution comprising a compound of the formula HOR¹ and a non-coordinating solvent.

In a third aspect, the disclosure provides the process of the first or second aspect, wherein R is chosen from methyl, ethyl, n-propyl, and isopropyl.

In a fourth aspect, the disclosure provides the process of the first, second, or third aspect, wherein R¹ is chosen from methyl, ethyl, n-propyl, and isopropyl.

In a fifth aspect, the disclosure provides the process of any one of the first through fourth aspects, wherein the compound of Formula (I) is dimethylaluminum isopropoxide.

In a sixth aspect, the disclosure provides the process of any one of the first through the fifth aspects, wherein the mixing is conducted within a static mixer.

In a seventh aspect, the disclosure provides the process of any one of the first through the sixth aspects, wherein the non-coordinating solvent is chosen from hydrocarbons having from 5 to 8 carbon atoms.

In an eighth aspect, the disclosure provides the process of the seventh aspect, wherein the non-coordinating solvent is chosen from n-hexane and n-heptane

In a ninth aspect, the disclosure provides the process of any one of the first through seventh aspects, wherein the non-coordinating solvent is chosen from benzene, toluene, and xylenes.

In a tenth aspect, the disclosure provides the process of any one of the first through the ninth aspects, wherein the mixing is conducted at a temperature of greater than about 10° C.

In an eleventh aspect, the disclosure provides the process of any one of the first through ninth aspects, wherein the mixing is conducted at a temperature of about 10° C. to about 95° C.

In a twelfth aspect, the disclosure provides the process of any one of the first through the ninth aspects, wherein the mixing is conducted at a temperature of about 10° to about 40° C.

In a thirteenth aspect, the disclosure provides the process of any one of the first through the twelfth aspects, wherein the mixing is conducted within two or more static mixers connected serially.

In a fourteenth aspect, the disclosure provides the process of any one of the first through the twelfth aspects, wherein the compound of the formula (R)₃Al is dissolved in a non-coordinating solvent at a concentration of about 0.5 to about 5.0 M.

In a fifteenth aspect, the disclosure provides the process of any one of the first or the third through fourteenth aspects, wherein the compound of the formula Al(OR¹)₃ is dissolved in a non-coordinating solvent at a concentration of about 0.2 to about 4.0M.

In a sixteenth aspect, the disclosure provides the process of any one of the first through fifteenth aspects, further comprising the step of distilling the compound of the formula (R)₃Al prior to use.

In a seventeenth aspect, the disclosure provides the process of the first or third through sixteenth aspects, further comprising the step of filtering the compound of the formula Al(OR¹)₃ prior to use.

In an eighteenth aspect, the disclosure provides a compound of the Formula (I):

(R)₂Al—OR¹ (I),
wherein each R is independently chosen from a C₁-C₈ alkyl group, and R¹ is a C₁-C₈ alkyl group; wherein the compound comprises about 20 to about 2000 ppm of a non-coordinating solvent.

In a nineteenth aspect, the disclosure provides the compound of the eighteenth aspect, wherein the compound of Formula (I) is dimethyl aluminum isopropoxide.

In a twentieth aspect, the disclosure provides a compound of the Formula (I):

(R)₂Al—OR¹ (I),
wherein each R is independently chosen from a C₁-C₃ alkyl group, and R¹ is C₁-C₃ alkyl; wherein the compound comprises no more than about 1200 ppm of a trimer or tetramer of a compound of Formula (I) and/or no more than about 2500 ppm of combined trimer/tetramer of a compound of Formula (I).

In a twenty-first aspect, the disclosure provides the compound of the twentieth aspect, wherein the compound of Formula (I) is dimethyl aluminum isopropoxide.

In a twenty-second aspect, the disclosure provides a compound of the Formula (I):

(R)₂Al—OR¹ (I),
wherein each R is independently chosen from a C₁-C₈ alkyl group, and R¹ is a C₁-C₈ alkyl group, prepared by the process of any one of the first through the seventeenth aspects.

In a twenty-third aspect, the disclosure provides the compound of the twenty-second aspect, which is dimethylaluminum isopropoxide.

In a twenty-fourth aspect, the disclosure provides a process for preparing a compound of the Formula (I):

(R)2Al—OR1 (I),
wherein each R is independently chosen from a C1-C8 alkyl group, and R1 is a C1-C8 alkyl group; the process comprising mixing (i) a solution comprising a compound of the formula (R)3Al and a non-coordinating solvent, with (ii) a compound of the formula Al(OR1)3 without solvent.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A process for preparing a compound of the Formula (I):
(R)₂Al—OR¹ (I),
wherein each R is independently chosen from a C₁-C₈ alkyl group, and R¹ is a C₁-C₈ alkyl group;
the process comprising mixing (i) a solution comprising a compound of the formula (R)₃Al and a non-coordinating solvent, with (ii) a solution comprising a compound of the formula Al(OR¹)₃ and a non-coordinating sol vent.

2. A process for preparing a compound of the Formula (I):
(R)₂Al—OR¹ (I),
wherein each R is independently chosen from a C₁-C₈ alkyl group, and R¹ is a C₁-C₈ alkyl group;
the process comprising mixing (i) a solution comprising a compound of the formula (R)₃Al and a non-coordinating solvent, with (ii) a solution comprising a compound of the formula HOR¹ and a non-coordinating solvent.

3. The process of claim 1 or 2, wherein R is chosen from methyl, ethyl, n-propyl, and isopropyl.

4. The process of claim 1 or 2, wherein R¹ is chosen from methyl, ethyl, n-propyl, and isopropyl.

5. The process of claim 1 or 2, wherein the compound of Formula (I) is dimethylaluminum isopropoxide.

6. The process of claim 1, wherein the mixing is conducted within a static mixer.

7. The process of claim 1, wherein the non-coordinating solvent is chosen from hydrocarbons having from 5 to 8 carbon atoms.

8. The process of claim 7, wherein the non-coordinating solvent is chosen from n-hexane and n-heptane and isomers thereof.

9. The process of claim 1, wherein the non-coordinating solvent is chosen from benzene, toluene, and xylenes.

10. The process of claim 1, wherein the non-coordinating solvent is chosen from a heavier, high boiling, hydrocarbon having 12 to 18 carbon atoms.

11. The process of claim 10, wherein the non-coordinating solvent is chosen from hydrocarbons n-dodecane, and n-tetradecane, and isomers thereof.

12. The process of claim 1, where the non-coordinating solvent is a mixture high-boiling hydrocarbons such as isoparaffinic fluids.

13. The process of claim 1, wherein the mixing is conducted at a temperature of greater than about 10° C.

14. The process of claim 1, wherein the mixing is conducted at a temperature of about 10° C. to about 95° C.

15. The process of claim 1, wherein the mixing is conducted at a temperature of about 10° to about 40° C.

16. The process of claim 1, wherein the mixing is conducted within two or more static mixers connected serially.

17. The process of claim 1, wherein the compound of the formula (R)₃Al is dissolved in a non-coordinating solvent at a concentration of about 0.5 to about 5.0 M.

18. The process of claim 1, wherein the compound of the formula Al(OR¹)₃ is dissolved in a non-coordinating solvent at a concentration of about 0.2 to about 4.0M.

19. The process of claim 1, further comprising the step of distilling the compound of the formula (R)₃Al prior to use.

20. The process of claim 1, further comprising the step of filtering the compound of the formula Al(OR¹)₃ prior to use.

21. A compound of the Formula (I):
(R)₂Al—OR¹ (I),
wherein each R is independently chosen from a C₁-C₈ alkyl group, and R¹ is a C₁-C₈ alkyl group; wherein the compound comprises about 20 to about 2000 ppm of a non-coordinating solvent.

22. The compound of claim 21, wherein the compound of Formula (I) is dimethyl aluminum isopropoxide.

23. A compound of the Formula (I):
(R)₂Al—OR¹ (I),
wherein each R is independently chosen from a C₁-C₈ alkyl group, and R¹ is a C₁-C₃ alkyl group; wherein the compound comprises no more than about 1200 ppm of a trimer or tetramer of a compound of Formula (I) and/or no more than about 2500 ppm of combined trimer/tetramer of a compound of Formula (I).

24. The compound of claim 23, wherein the compound of Formula (I) is dimethyl aluminum isopropoxide.

25. A process for preparing a compound of the Formula (I):
(R)₂Al—OR¹ (I),
wherein each R is independently chosen from a C₁-C₈ alkyl group, and R¹ is a C₁-C₈ alkyl group;
the process comprising mixing (i) a solution comprising a compound of the formula (R)₃Al and a non-coordinating solvent, with (ii) a compound of the formula Al(OR¹)₃ without solvent.

26. The compound of claim 25, wherein the compound of Formula (I) is dimethylaluminum isopropoxide.
